(19) United States
(12) Patent Application Publication
(10) Pub. No.: US 2005/0241947 A1
(43) Pub. Date: Nov. 3, 2005

(54) System and method for an increased bath lifetime in a single-use plating regime

(76) Inventors: Markus Nopper, Dresden (DE); Axel Preusse, Radebeul (DE); Matthias Bonkass, Dresden (DE)

Correspondence Address: WILLIAMS, MORGAN & AMERSON, P.C., 10333 RICHMOND, SUITE 1100, HOUSTON, TX, 77042, US

(21) Appl. No.: 11/043,400

(22) Filed: Jan. 26, 2005

(30) Foreign Application Priority Data
Apr. 30, 2004 (DE) 10 2004 021 260.0

(51) Int. Cl. C25D 7/00; C25D 17/00; B01J 19/08

(52) U.S. Cl. 205/98; 204/242; 422/186.07

(57) ABSTRACT

A plating tool for a single-use plating process comprises a reclaim system in combination with a support tank to enable collection of non-consumed plating solution drained off from the process chamber, which is then re-circulated to the support tank after an efficient treatment in the reclaim system. Since the non-consumed plating solution is continuously recycled, the electrolyte may be preserved substantially without any time limit while at the same time production costs for a single-use plating process are significantly reduced.

### BACKGROUND OF THE INVENTION

1. Field of the Invention

The present invention generally relates to the field of fabrication of integrated circuits, and, more particularly, to manufacturing processes involving the application of plating solutions onto the surface of a substrate, wherein each substrate is supplied with a predefined amount of electrolyte, which is then immediately drained off to provide substantially uniform process conditions for each substrate.

2. Description of the Related Art

In an integrated circuit, a huge number of circuit elements, such as transistors, capacitors, resistors and the like, are formed in or on an appropriate substrate, usually in a substantially planar configuration. One important process stage during the formation of integrated circuits represents the field of forming metal-containing regions on a substrate by wet chemical processes, such as plating. Due to the large number of circuit elements and the required complex layout of the integrated circuits, generally the electrical connection of the individual circuit elements may not be established within the same level on which the circuit elements are manufactured, but requires one or more additional “wiring” layers, also referred to as metallization layers. These metallization layers generally include metal lines, providing for the inner-level electrical connection, and also include a plurality of inter-level connections, also referred to as vias, wherein the metal lines and vias may also be commonly referred to as interconnects. Furthermore, the connection of the integrated circuit or portions thereof to the periphery is usually established by a plurality of contact pads, which in sophisticated devices bear so-called solder bumps enabling a direct connection with corresponding areas of a package substrate by means of reflowing the solder bumps.

Two frequently used techniques for depositing a metal on a substrate are electroplating and electroless plating. In the electroless plating process, a catalytic material may be formed prior to bringing the metal-containing solution into contact with the substrate surface. In the electroplating process, a current distribution layer, sometimes referred to as a seed layer, is required to electrically connect the specified substrate regions that are intended to receive a metal with an external current source so that the metal-containing solution contacting the specified regions may be chemically reduced and deposited as a metal. Typically, the plating process is conducted in a plating tool comprising a plating chamber in which the substrate is brought into contact with the plating solution. Although simple bath reactors may be used for this purpose, it turns out that, for sophisticated applications, a fountain-type reactor is the preferred tool for plating metal onto a substrate. Generally, a fountain-type plating tool comprises a process chamber and separated therefrom a storage tank containing the plating solution, which is conveyed via a conduit system to the process chamber. In the process chamber, the plating solution is applied to the substrate, which is placed with its receiving surface to face the electrolyte stream, wherein, in currently used systems, the excess solution is re-circulated to the storage tank.

In sophisticated integrated circuits, frequently the so-called damascene technique is used in forming metallization layers, particularly when copper and copper compounds are deployed, since copper may not efficiently be deposited and patterned by well-established process techniques, such as chemical vapor deposition (CVD) and anisotropic etch processes. Thus, plating techniques seem to be the processes of choice for filling a copper-based metal into vias and trenches that are formed in an appropriate interlayer dielectric material. Although wet chemical copper and copper compound deposition techniques are well established in the field of fabrication of printed circuit boards, the reliable and reproducible filling in of copper and copper compounds in combination with a preceding deposition of very thin barrier layers is a highly complex task, requiring, for instance, the deposition of copper and copper compounds into vias with dimensions of 0.1 μm and even less with an aspect ratio of 5 and higher. Therefore, on a local scale, a highly non-conformal deposition process is required to fill the vias and trenches from bottom to top, while at the same time an excellent uniform global deposition rate is necessary to minimize across-substrate variations. As a consequence, the resulting uniformity of the metal layer deposited and/or the quality thereof with respect to the desired absence of voids in vias and trenches may significantly depend on the composition of the plating solution and the manner in which the plating solution is applied to the substrate. For example, a plurality of sensitive additives, mostly organic compounds, are contained in a plating solution to achieve the required deposition behavior and metal characteristics, that is, so-called brighteners, levelers and suppressors, among others, are mixed with a basic plating solution. Typically, some of these additives are highly unstable and may also readily react with other components, such as oxygen, so that the “aging” of these breakdown products may lead to a change of the process conditions, when non-consumed plating solution is continuously re-circulated to the storage tank of the plating tool, since even a minute shift of the composition of the plating solution may significantly affect the local deposition rate, thereby also limiting the total lifetime of the plating bath.

It has therefore been proposed to employ a so-called single-use scenario for sophisticated applications, such as copper deposition for integrated circuits of the 65-nm or 45-nm technology node. In this single-use approach, a predefined volume of the plating solution is supplied to the process chamber and is drained off the chamber after completion of the plating process of the single substrate. Since the non-consumed plating solution is discharged rather then recycled to the storage tank, the adverse influence of breakdown products, by-products and the like to the remaining plating solution is reduced, since then a decay of the sensitive additives mainly occurs in the process chamber during the plating process. Thus, the process conditions for the subsequent substrates may be maintained more uniform compared to the former approach. However, the single-use regime entails significantly increased costs of ownership owing to the high amount of expensive chemistry consumed and the process of disposing and/or reworking or treating the increased amount of toxic waste products.

In view of the above-explained situation, a need exists for an efficient technique that prevents, or at least reduces, one or more of the problems described above.

### SUMMARY OF THE INVENTION

The following presents a simplified summary of the invention in order to provide a basic understanding of some aspects of the invention. This summary is not an exhaustive overview of the invention. It is not intended to identify key or critical elements of the invention or to delineate the scope of the invention. Its sole purpose is to present some concepts in a simplified form as a prelude to the more detailed description that is discussed later.

Generally, the present invention is directed to an apparatus and a method for plating substrates according to the single-use regime, in which a predefined amount of plating solution is supplied to a single substrate or a limited number of substrates, whereby one or more of the problems identified above may be avoided or at least reduced in that the plating solution drained off the process chamber after completion of the plating process for the single substrate or the limited number of substrates is reclaimed and then reused for another substrate.

According to one illustrative embodiment of the present invention, a plating tool comprises a process chamber, a support tank configured to receive and contain a plating solution and a supply system connected to the process chamber and the support tank, wherein the supply system is configured to supply an adjustable amount of plating solution to the process chamber. Moreover, the plating tool comprises a reclaim system connected to the process chamber and the support tank, wherein the reclaim system is configured to receive non-consumed plating solution from the process chamber and to supply to the support tank reclaimed plating solution obtained from the non-consumed plating solution.

According to yet another illustrative embodiment of the present invention, a method of operating a plating tool comprises supplying a predefined amount of a plating solution including at least one organic additive from a support tank to a substrate. A non-consumed portion of the plating solution is then collected and reclaimed. Finally, the non-consumed portion is supplied as a reclaimed plating solution to the support tank for reuse with another substrate.

### BRIEF DESCRIPTION OF THE DRAWINGS

The invention may be understood by reference to the following description taken in conjunction with the accompanying drawings, in which like reference numerals identify like elements, and in which:

FIG. 1a schematically illustrates a basic illustrative embodiment of the present invention, which includes a reclaim system for reworking plating solution drained off a process chamber;

FIGS. 1b and 1c schematically illustrate further illustrative embodiments of a plating tool including a reclaim system; and

FIG. 2 schematically shows a plating tool according to a further illustrative embodiment of the present invention, in which a control unit is provided for controlling the operation of the reclaim system on the basis of measurement results.

While the invention is susceptible to various modifications and alternative forms, specific embodiments thereof have been shown by way of example in the drawings and are herein described in detail. It should be understood, however, that the description herein of specific embodiments is not intended to limit the invention to the particular forms disclosed, but on the contrary, the intention is to cover all modifications, equivalents, and alternatives falling within the spirit and scope of the invention as defined by the appended claims.

### DETAILED DESCRIPTION OF THE INVENTION

Illustrative embodiments of the invention are described below. In the interest of clarity, not all features of an actual implementation are described in this specification. It will of course be appreciated that in the development of any such actual embodiment, numerous implementation-specific decisions must be made to achieve the developers' specific goals, such as compliance with system-related and business-related constraints, which will vary from one implementation to another. Moreover, it will be appreciated that such a development effort might be complex and time-consuming, but would nevertheless be a routine undertaking for those of ordinary skill in the art having the benefit of this disclosure.

The present invention will now be described with reference to the attached figures. Although the various regions and structures of a semiconductor device are depicted in the drawings as having very precise, sharp configurations and profiles, those skilled in the art recognize that, in reality, these regions and structures are not as precise as indicated in the drawings. Additionally, the relative sizes of the various features and doped regions depicted in the drawings may be exaggerated or reduced as compared to the size of those features or regions on fabricated devices. Nevertheless, the attached drawings are included to describe and explain illustrative examples of the present invention. The words and phrases used herein should be understood and interpreted to have a meaning consistent with the understanding of those words and phrases by those skilled in the relevant art. No special definition of a term or phrase, i.e., a definition that is different from the ordinary and customary meaning as understood by those skilled in the art, is intended to be implied by consistent usage of the term or phrase herein. To the extent that a term or phrase is intended to have a special meaning, i.e., a meaning other than that understood by skilled artisans, such a special definition will be expressly set forth in the specification in a definitional manner that directly and unequivocally provides the special definition for the term or phrase.

With reference to the drawings, further illustrative embodiments of the present invention will now be described in more detail. It should be appreciated that the present invention is particularly useful in combination with copper plating tools, since sophisticated modem integrated circuits include metallization layers with extremely scaled metal lines and vias requiring highly conductive metals, such as copper and copper alloys. Due to the reduced feature sizes, even a very subtle change of process conditions may, therefore, significantly affect the characteristics of the metal lines and vias so that a predefined amount of plating solution is supplied, advantageously, for each single substrate to be processed, wherein plating solution drained off is collected and reclaimed for use with subsequent substrates, thereby remarkably reducing chemistry consumption and chemical waste disposal or treatment. Moreover, compared to a conventional approach using a fresh plating solution for each substrate, the present invention enables tailoring of the electrolyte bath constitution in accordance with specific process requirements by, for instance, selectively removing unwanted breakdown products while at the same time maintaining desired breakdown products created during the process cycle. The present invention may, however, also be applied to any plating tools and plating processes, irrespective of whether electroless plating or electroplating is considered, with plating solutions containing additionally or alternatively other materials than copper, wherein the microstructures involved may have critical dimensions well beyond 100 nm or wherein the dimensions of the structures to be plated are significantly larger. For instance, the present invention may readily be applied to microstructures and integrated circuits having moderate feature sizes, that is, less critical sizes compared to cutting-edge products, wherein the plating process with a predefined amount of plating solution with subsequent reclaiming of non-consumed portions may enhance product reliability and production yield compared to conventional approaches, while still maintaining production costs at low level. Another example may be the formation of solder bumps for connecting to a corresponding substrate, wherein the present invention may provide enhanced uniformity for the solder bumps as especially the number thereof increase, while the size and the spacing decreases with every new circuit generation.

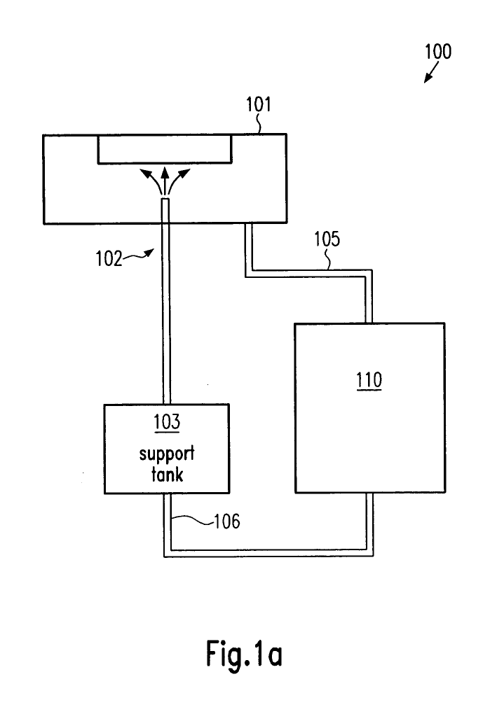

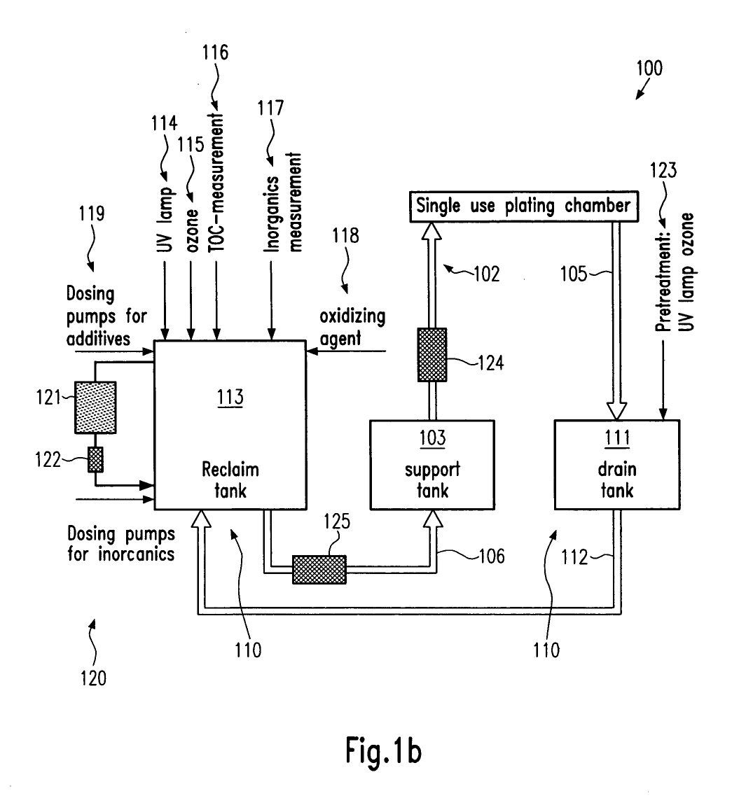

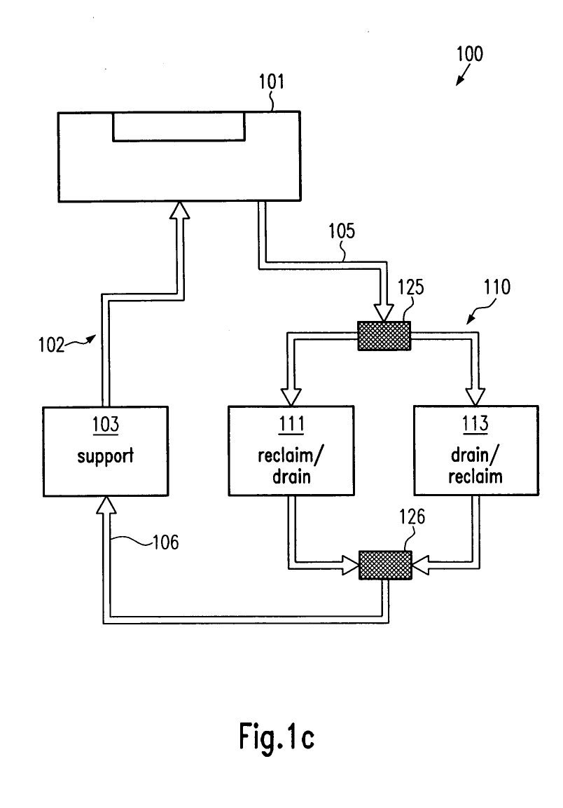

FIG. 1a schematically shows a plating tool 100 in accordance with one illustrative embodiment of the present invention. The plating tool 100 comprises a process chamber 101 that is configured to receive and hold in place a substrate 101a, which is to be plated with an appropriate metal, such as a copper-based metal. The process camber 101 is coupled to a supply system 102, which, in turn, is configured to provide an adjustable amount of plating solution to the process chamber 101. For this purpose, a dosing pump and/or a controllable valve element (not shown), as is already known in the prior art, may be provided to supply in adjustable manner a predefined amount of plating solution to the process chamber 101. The supply system 102 is connected to a support tank 103 containing a plating solution of a required composition. For instance, the plating solution may represent an electrolyte including one or more organic additives that provide the required plating behavior in combination with a specified plating process. As previously noted, sophisticated integrated circuits may require a copper-based metallization, wherein minute amounts of organic additives may be required to achieve an appropriate deposition process. For instance, a copper-based seed layer for a subsequent electroplating process for the bulk metal material may be applied by an electroless seed layer process, wherein sensitive organic components have to be introduced into the plating solution with a precisely controlled concentration. In other embodiments, the support tank 103 may contain an electroplating solution on the basis of copper requiring, for instance, brighteners, levelers and suppressors and the like, to ensure a fill behavior from bottom to top to reliably and substantially void-free filling vias and trenches.

The process chamber 101 is also connected to a drain line 105, which, in turn, is connected to a reclaim system 110 that is connected to the support tank 103 by a line 106. The reclaim system 110 is configured to receive a non-consumed portion of plating solution supplied by the drain line 105, and may also be configured to rework the non-consumed plating solution by, for instance, selectively removing at least one unwanted component in the plating solution, as will be described in more detail with reference to FIG. 1b.

In operation, the plating tool 100 may provide a predefined amount of plating solution from the support tank 103 to the process chamber 101 via the supply system 102, wherein the predefined amount may, in one embodiment, be adjustable in accordance with process requirements. For example, the predefined amount of plating solution may depend on the substrate size, the specific substrate layer to be coated with a metal, the type of metal layer to be formed, such as a seed layer or a bulk metal layer, and the like. Moreover, although it is highly advantageous for sophisticated semiconductor devices to provide the predefined amount of plating solution, according to one particular embodiment, for each single substrate to be processed in the chamber 101, in less critical applications, the predefined amount of the plating solution introduced by the supply system 102 may be selected for two or more substrates, for example when a bath-like reactor is used. During and/or after the plating process, non-consumed plating solution, some ingredients of which may undergo a decay or chemical reaction, thereby creating unwanted and desired by-products in the non-consumed plating solution, is drained off the process chamber 101 by means of the drain line 105 and supplied to the reclaim system 110, in which one or more unwanted components may selectively be removed from the non-consumed plating solution by, for instance, appropriately selected or adjusted filter elements, such as active carbon filters and the like. In other embodiments, as will be described in more detail with reference to FIG. 1b, one or more organic additives may be treated to undergo a chemical reaction, that is the one or more organic additives may be treated to be cracked or a decay thereof may be initiated, so that one or more by-products of this reaction may more easily be removed from the plating solution compared to the original organic additive.

In one embodiment, the reclaim system 110 is also configured to replenish one or more additives to establish a required concentration of the one or more additives within the reclaimed plating solution prior to supplying the reclaimed plating solution to the support tank 103 via the line 106. Consequently, the support tank 103 receiving the reclaimed plating solution contains the plating solution corresponding to a specified prescribed state, wherein the lifetime of the electrolyte in the support tank 103 is substantially not limited except for the amount of solution coated onto the substrate, while the delicate concentrations of the additives and possibly of any wanted by-products created by the deposition process are maintained within a specified range by means of the reclaim system 110. As a consequence, the operation of the plating tool 100 may not only be advantageous with respect to chemistry consumption and effort in treating or disposing of waste products of the plating process, but also in view of adjusting the characteristics of the plating solution, as, for example, specified by-products may be maintained that may not be present in a fresh plating solution as is typically used in single-use plating tools of the prior art.

FIG. 1b schematically shows the plating tool 100 according to further illustrative embodiments. In one particular embodiment, the reclaim system 110 comprises a drain tank 111 that is connected by means of a line 112 with a reclaim tank 113. The drain tank 111 is also connected to the drain line 105 to receive the non-consumed plating solution from the process chamber 101. The line 112 may comprise any appropriate means for controlling or adjusting the supply of the non-consumed plating solution to the reclaim tank 113. For instance, appropriate means for supplying the solution from the drain tank 111 to the reclaim tank 113 may include controllable valve elements and/or pumps, and the like, which are for convenience not shown in FIG. 1b. The drain tank 111 may comprise a treatment device 123 associated therewith, such as an ultraviolet radiation source and/or an ozone generator, which is arranged such that the non-consumed plating solution within the drain tank 111 may be subjected to a pretreatment for initiating a decay of at least one organic additive. In other embodiments, the treatment device 123 may comprise, additionally or alternatively, a source of an oxidizing agent, such as sulfuric acid, hydrogen peroxide and the like, to crack or initiate a decay of one or more additives by oxidation.

The reclaim tank 113 is configured to actually rework the plating solution delivered by the drain tank 111. In one embodiment, the reclaim tank 113 may be coupled to a treatment unit 114A, which may comprise an ultraviolet radiation source 114 and/or an ozone generator 115 and/or a source 118 for delivering an oxidizing agent. In other embodiments, the reclaim system 110 may additionally comprise a measurement system 116 configured to determine the amount of at least one organic component within the plating solution in the reclaim tank 113. For instance, the measurement system 116 may comprise a device for cyclic voltametric stripping measurements (CVS), as is well known in the art, for determining the concentration of additives in electrolyte baths. The measurement system 116 may additionally or alternatively comprise other measurement devices that are well known in the art of determining components and concentrations of electrolyte solutions. In still a further illustrative embodiment, the reclaim system 110 may further comprise a measurement system 117 that is configured to determine the concentration of at least one inorganic component of the plating solution in the reclaim tank 113. For instance, the measurement system 117 may be equipped with spectrometry devices, autotitration devices, and the like to determine an indication for a concentration of fluorides, copper, sulfates or any other inorganic components of the plating solution in the reclaim tank 113. Moreover, the reclaim system 110 may comprise a filter element 121 for selectively removing or at least reducing at least one specified component from the solution in the reclaim tank 113. For example, the filter element 121 may be provided in the form of an active carbon filter to remove by-products of a chemical reaction initiated by the treatment unit 114A, that is by one or more of the devices 114 and/or 115 and/or 118. In other embodiments, additionally or alternatively, the filter element 121 may be configured to selectively remove any unwanted breakdown products, while substantially maintaining desired breakdown products, wherein the filter element 121 may be provided in combination with one or more of the devices 114, 115 and 118 or may be provided without any of these devices. In one particular embodiment, the filter element 121 is provided in combination with a particle filter 122 configured to remove particles having a size above a specified threshold. As shown, the filter element 121 may be arranged such that the solution in the reclaim tank 113 is effectively re-circulated within the tank 113, which may be accomplished by, for instance, a re-circulation circuit or any other appropriate means that enables maintaining a convection or re-circulation within the reclaim tank 113. For instance, a circulation pump (not shown) may be provided to continuously or temporarily circulate the plating solution in the reclaim tank 113. In other embodiments, one or more dosing pumps 120 are additionally provided to supply inorganic components, such as acid, sulfates, chlorides and the like. Moreover, as illustrated in some embodiments, a particle filter 125 may be provided in the line 106 connecting the reclaim tank 113 with the support tank 103, and/or a particle filter 124 may be provided within the supply system 102.

During operation of the plating tool 100 of FIG. 1b, the non-consumed plating solution is supplied to the drain tank 111, which may serve as a buffer to controllably deliver the non-consumed plating solution to the reclaim tank 113. When the treatment device 123 is provided in combination with the drain tank 111, the non-consumed plating solution buffered in the drain tank 111 may be subjected to a pre-treatment, thereby reducing the dwell time of the solution in the reclaim tank 113. During the pre-treatment, the non-consumed plating solution may be selectively filtered and/or treated by ultraviolet radiation and/or ozone and/or an oxidizing agent to crack additives and/or remove at least partially unwanted by-products. Depending on the operating conditions of the process chamber 101, more or less non-consumed plating solution may be delivered to the drain tank 111, thereby affecting the efficiency of the pre-treatment. That is, when substrates are continuously processed within the chamber 101, a moderately high amount of non-consumed plating solution is delivered to the drain tank 111, thereby “diluting” the pretreated solution that is already contained in the drain tank 111. Hence, the capacity of the treatment device 123 and/or the adjustment of any treatment devices included therein may be adapted to specific process conditions such that a desired pre-treatment effect is achieved. For instance, by means of a measurement device, similar to the devices 116 and/or 117, one or more characteristics of the non-consumed plating solution within the drain tank 111 may be determined and may be used to correspondingly adjust the operation of the treatment device 123, thereby achieving a substantially constant pre-treatment effect in accordance with process conditions in the process chamber 101.

A portion of the non-consumed plating solution of the drain tank 111 may, irrespective of whether any pre-treatment is carried out or not, be supplied to the reclaim tank 113 by means of the line 112, wherein, as previously noted, the supply of plating solution to the reclaim tank 113 may be performed in a controlled manner. For example, the supply of plating solution to the reclaim tank 113 may be controlled on the basis of operating conditions in the drain tank 111, such as fluid level, pre-treatment status of the plating solution, and the like, and/or may be controlled on the basis of the status of the reclaim tank 113, such as fluid level, status of the devices for reclaiming the fluid in the tank 113 and the like. In other embodiments, a substantially continuous supply of plating solution from the drain tank 111 to the reclaim tank 113 may be provided, wherein the flow rate may be controlled to correspond to the required operating conditions of the drain tank 111 and/or the reclaim tank 113. It should be appreciated that the size and capacity of the reclaim system 110 is advantageously adapted to a maximum throughput of the process chamber 101 so that, even at a maximum utilization of the tool 100, the operation may be maintained substantially without requiring the introduction of significant amounts of fresh plating solution.

In the reclaim tank 113, a convection or circulation of the plating solution contained therein may be established, for instance by means of a pump, to remove unwanted substances and/or particles by means of the filter element 121 and the particle filter 122. Since the filter element 121 may be provided in the form of a selective filter unit, any desired substances may be maintained, which may have formed during the cycling through the process chamber 101, thereby enabling the adjustment of a desired state of the plating solution that differs from a less effective state of a fresh plating solution. Alternatively or additionally, the ultraviolet radiation source 114 and/or the ozone generator 115 and/or the supply for the oxidizing agent 118 may be activated to initiate a decay of organic additives, the by-products of which may then be removed, for instance by the filter element 121 or any other appropriate means. The total concentration of organic compounds or the concentration of one or more specific organic compounds may be monitored by the measurement device 116, while the concentrations of at least one inorganic compound may be monitored by the measurement device 117. In some embodiments, the operation of the treatment devices 114 and/or 115 and/or 118 may be controlled on the basis of the measurement results from the devices 116 and/or 117, as will be described later.

The reclaim system 110 may, in a further embodiment, comprise one or more dosing pumps 119 for controllably introducing one or more additives to the plating solution in the reclaim tank 113.

In other embodiments, the one or more dosing pumps 119 for introducing any additives into the reclaim tank 113 as well as the operation of the dosing pumps 120 for providing inorganic compounds may be based on the measurement results obtained from the devices 116 and/or 117. In this way, a desired composition of the plating solution may be obtained within the reclaim tank 113 and may then finally be supplied to the support tank 103 by means of the line 106, wherein the particle filter 125 may further reduce any unwanted particles above a predetermined size. The support tank 103, which has a capacity sufficient to span any delays in providing the reclaimed plating solution, therefore, contains a plating solution in accordance with specified requirements, wherein, except for minor losses caused by deposition and leakage, the lifetime of the electrolyte bath, i.e., of the plating solution, is substantially not restricted as is the case in conventional plating tools. From the support tank 103, the reclaimed plating solution may be pumped to the process chamber 101 through the particle filter 124 to again remove any particle and/or bubbles that may still be contained in the plating solution.

It should be appreciated that the embodiment as depicted in FIG. 1b is of an illustrative nature only and various modifications may be performed. For instance, in some embodiments, two or more drain tanks 111 may be provided to enable an efficient pre-treatment with a predefined volume of plating solution once one of the drain tanks 111 has reached a specified level at which the non-consumed plating solution from the chamber 101 is then directed to another one of the drain tanks 111 by a corresponding valve element. In this case, a plating solution of well-defined pretreatment status may be supplied to the reclaim tank 113 from one of the drain tanks 111 while one or more of the other drain tanks may receive non-consumed plating solution without affecting the pretreatment process. Similarly, two or more reclaim tanks 113 may be provided to enable an efficient reclaim process of the plating solution, wherein, for instance, each of the reclaim tanks 113 is configured to perform one or more specified tasks, such as particle filtering, cracking organic additives, dosing additives, and the like. Thus, by performing two or more tasks sequentially in different reclaim tanks 113, each process step during reclaiming the plating solution may be performed more efficiently compared to a single reclaim tank 113.

FIG. 1c schematically shows a further illustrative embodiment of the plating tool 100, in which the reclaim system 110 comprises a first switchable valve element 127 that is configured to direct the non-consumed plating solution delivered by the drain line 105 to a first reclaim/drain tank 111 and a second drain/reclaim tank 113. The reclaim system 110 further comprises a second switchable valve element 126 that is configured to selectively receive plating solution from the tanks 111 and 113 and to connect one of the tanks with the line 106 connected to the support tank 103. The tanks 111 and 113 may each be equipped as is shown in FIG. 1b for the reclaim tank 113 to produce a reclaimed plating solution that may be supplied to the support tank 103.

During operation of the plating tool 100, one of the tanks 111, 113 may be selected as a drain tank during a first phase of the plating process, for instance the tank 113, while the other tank 111 is cut off from the drain line 105 by means of the switchable valve element 127. The tank 111 may then be used to efficiently reclaim the plating solution contained therein, while the tank 113 serves as a drain buffer during the ongoing plating process in the chamber 101. It should be noted that in some embodiments a plurality of tanks 111, 113 may be provided, when for instance, the time period for reclaiming a solution in the tank 111 exceeds the time period required for completely filling the tank 113 during the plating process. After the reclaiming process in the tank 111 is completed, the plating solution contained therein may be provided via the switchable valve element 126 to the support tank 103 and may be reused in the ongoing plating process. At this time, the tank 111 may be selected as the drain tank by correspondingly switching the valve element 127, thereby decoupling the tank 113 from the drain line 105. During this phase, the tank 113 may be operated as a reclaim tank to efficiently rework the plating solution contained therein, which may then be supplied to the support tank 103 for a further reuse.

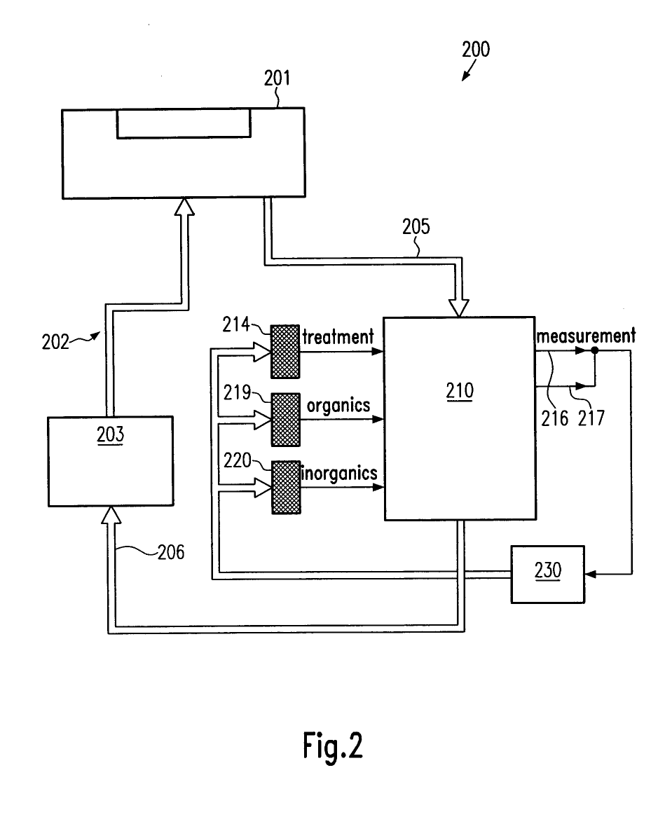

FIG. 2 schematically shows a further illustrative embodiment of a plating tool 200 comprising a reclaim system 210 connected to a process chamber 201 via a drain line 205. The reclaim system 210 is connected to a support tank 203 by means of a line 206, while the support tank 203 is connected to the process chamber 201 by a supply system 202. The reclaim system 210 may comprise a measurement device 216 for determining at least one organic component and/or a measurement device 217 for determining at least one inorganic component. Moreover, the reclaim system 210 comprises a treatment unit 214, a supply unit 219 for supplying organic additives and/or a supply unit 220 for supplying inorganic compounds to a plating solution contained in the reclaim system 210. With respect to the reclaim system 210, it is to be noted that it may be arranged in a similar fashion as is already described with reference to the reclaim system 110 shown in FIGS. 1a-1c. The plating tool 200 further comprises a control unit 230 that may be connected to at least one of the measurement devices 216 and 217 and to at least one of the units 214, 219 and 220.

During the operation of the plating tool 200, the control unit 230 may receive measurement results of at least one of the measurement devices 216, 217, wherein the measurement results include information or an indication of a characteristic of at least one component of the plating solution supplied to the reclaim system 210. For example, a cyclic voltametric stripping measurement may be performed to determine a concentration of one or more additives within the plating solution. Based on the measurement results, the control unit 230 may determine a setting value for one or more control parameters of the units 214 and/or 219 and/or 220 to control the operation thereof on the basis of the measurement results obtained. For instance, the measurement results obtained by the control unit 230 may indicate the concentration of one or more unwanted breakdown products in the plating solution and a corresponding filter element, and/or an ozone generator and/or a UV radiation source and/or a source for delivering an oxidizing agent may correspondingly be driven by the control unit 230 to more efficiently or less efficiently remove the one or more unwanted breakdown products, if the determined concentration is higher or lower than the specified threshold or value range. Similarly, a measurement result may indicate the concentration of required additives. Based on the result, a corresponding dosing pump, controlled by the unit 230, may then supply a specific organic additive with a required dosage. The same holds true for the supply of any inorganic compounds to the plating solution, wherein the operation of the unit 220 may be controlled on the basis of corresponding measurement results. Thus, a control loop may be established by means of the control unit 230, thereby enabling a more efficient and automatic monitoring and controlling of the reclaim process of the plating solution, which may thus be contained within tight process margins in an automated fashion.

As a result, the present invention provides a plating tool and a method of operating the same, wherein a single-use plating process may be performed while the quality of an electrolyte bath may be maintained within specified requirements by correspondingly reclaiming non-consumed plating solution. Since most of the plating solution is re-circulated to a support tank, not only production costs may be significantly lowered due to the elimination of undue chemistry waste and efforts in disposing/treating of by-products of the plating process, but also specified characteristics of the plating solution may be maintained substantially without any time limit, wherein particularly desired breakdown products generated during the process cycle may be preserved within the plating solution.

The particular embodiments disclosed above are illustrative only, as the invention may be modified and practiced in different but equivalent manners apparent to those skilled in the art having the benefit of the teachings herein. For example, the process steps set forth above may be performed in a different order. Furthermore, no limitations are intended to the details of construction or design herein shown, other than as described in the claims below. It is therefore evident that the particular embodiments disclosed above may be altered or modified and all such variations are considered within the scope and spirit of the invention. Accordingly, the protection sought herein is as set forth in the claims below.

1. A plating tool, comprising:
a process chamber;
a support tank configured to receive and contain a plating solution;
a supply system connected to said process chamber and said support tank and configured to supply an adjustable amount of plating solution to said process chamber; and
a reclaim system connected to said process chamber and to said support tank, said reclaim system being configured to receive non-consumed plating solution from said process chamber and to supply to said support tank reclaimed plating solution obtained from said non-consumed plating solution.

2. The plating tool of claim 1, wherein said reclaim system is configured to initiate a controlled decay of at least one organic additive of said non-consumed plating solution.

3. The plating tool of claim 2, wherein said reclaim system comprises at least one of an ultraviolet radiation source, an ozone generator and a supply for an oxidizing agent.

4. The plating tool of claim 1, wherein said reclaim system comprises a selective filter unit that is configured to selectively remove at least one specified component contained in said non-consumed plating solution.

5. The plating tool of claim 3, wherein said reclaim system comprises a filter unit configured to remove byproducts generated by said decay of said at least one organic additive.

6. The plating tool of claim 1, wherein said reclaim system comprises a measurement device configured to determine a status of at least one of said non-consumed plating solution and said reclaimed plating solution.

7. The plating tool of claim 6, further comprising a control unit connected to said measurement device and configured to provide control information used to adjust said replenishment system.

8. The plating tool of claim 6, wherein said measurement device comprises a detector section configured to detect a total organic content of at least one of said non-consumed plating solution and said reclaimed plating solution.

9. The plating tool of claim 6, wherein said measurement device comprises a detector section configured to determine an amount of at least one inorganic component of at least one of the non-consumed plating solution and said reclaimed plating solution.

10. The plating tool of claim 6, further comprising a control unit operatively connected to said measurement device, said control unit being configured to provide control information for adjusting a controlled decay of at least one additive of said non-consumed plating solution.

11. The plating tool of claim 10, wherein said control unit is connected to form a control loop with at least one of an ultraviolet radiation source, an ozone generator and a supply for an oxidizing agent provided in said reclaim system to adjust the controlled decay on the basis of said control information.

12. The plating tool of claim 1, further comprising a replenishment system connected to said reclaim system, said replenishment system being configured to provide at least one additive to said reclaim system.

13. The plating tool of claim 12, further comprising a control unit connected to said measurement device and configured to provide control information used to adjust said replenishment system.

14. The plating tool of 13, wherein said control unit is connected to form a control loop with said measurement device and said replenishment system to adjust the provision of said at least one additive to said reclaim system on the basis of said control information.

15. The plating tool of claim 1, wherein said reclaim system comprises a drain tank for receiving and temporarily buffering said non-consumed plating solution from said process chamber.

16. The plating tool of claim 15, further comprising at least one of an ultraviolet radiation source, an ozone generator and a supply for an oxidizing agent, wherein said at least one of an ultraviolet radiation source, an ozone generator and a supply for an oxidizing agent is coupled to said drain tank for pre-treating said non-consumed plating solution.

17. The plating tool of claim 15, further comprising a reclaim tank connected to said drain tank to receive plating solution therefrom.

18. The plating tool of claim 17, further comprising at least one of an ultraviolet radiation source, an ozone generator, a supply for an oxidizing agent and a selective filter element, all of which are coupled to said reclaim tank.

19. The plating tool of claim 18, further comprising a particle filter device connected to said reclaim tank, said particle filter device being configured to reduce the amount of particles of a plating solution contained in the reclaim tank.

20. The plating tool of claim 17, further comprising a particle filter within a line connecting the reclaim tank with said support tank.

21. The plating tool of claim 20, further comprising a second particle filter within a second line connecting said support tank and said process chamber.

22. The plating tool of claim 17, further comprising a supply unit configured to supply one or more inorganic components of the plating solution to said reclaim tank.

23. A method of operating a plating tool, the method comprising:
supplying a predefined amount of a plating solution including at least one organic additive from a support tank to a substrate;
collecting a non-consumed portion of said plating solution;
reclaiming said non-consumed portion of said plating solution; and
supplying said non-consumed portion as a reclaimed plating solution to said support tank for reuse with another substrate.

24. The method of claim 23, wherein reclaiming said non-consumed portion comprises initiating a decay of said at least one organic additive.

25. The method of claim 24, wherein reclaiming said non-consumed portion comprises selectively filtering said non-consumed portion to reduce at least one unwanted component.

26. The method of claim 24, wherein reclaiming said non-consumed portion further comprises removing at least one by-product of the decay of said at least one organic additive.

27. The method of claim 23, further comprising determining at least one characteristic of at least one of said non-consumed portion and said reclaimed plating solution, and controlling said reclaiming process on the basis of said at least one characteristic.

28. The method of claim 27, wherein said at least one characteristic comprises an indication of a concentration of at least one of said at least one organic additive and a decay product thereof.

29. The method of claim 27, wherein said at least one characteristic comprises an indication of a concentration of at least one inorganic component of said plating solution.

30. The method of claim 27, further comprising replenishing said at least one organic additive on the basis of said at least one characteristic prior to supplying said reclaimed plating solution to said support tank.

31. The method of claim 27, further comprising replenishing at least one inorganic component on the basis of said at least one characteristic prior to supplying said reclaimed plating solution to said support tank.

32. The method of claim 23, further comprising pretreating said non-consumed portion prior to reclaiming the same to initiate a decay of said at least one organic additive.

33. The method of claim 23, wherein said predefined amount of plating solution is selected to serve as a plating solution for a single substrate.
